(19) United States
(12) Patent Application Publication
(10) Pub. No.: US 2008/0097787 A1
(43) Pub. Date: Apr. 24, 2008

(54) Multi-dose pharmacy label

(75) Inventors: Christina Palazzolo, Chicago, IL (US); Rodney Stogsdill, Ocoee, FL (US)

Correspondence Address: FRANCIS KOWALIK/WALGREEN CO. LAW DEPT. M.S. 1425, 104 WILMOT ROAD, DEERFIELD, IL, 60015, US

(73) Assignee: Walgreen Co.

(21) Appl. No.: 11/584,926

(22) Filed: Oct. 23, 2006

(51) Int. Cl. G06Q 10/00; B42D 15/00

(52) U.S. Cl. 705/2; 283/70

(57) ABSTRACT

A pharmacy label includes a patient section, a first drug section, and a second drug section. The patient section has patient-specific information printed thereon, and the first and second drug sections have first and second drug-specific information printed thereon, respectively. The patient section further contains a prescription number printed thereon. The prescription number is correlated to the patient-specific information, the first drug-specific information, and the second drug-specific information.

### CROSS-REFERENCE TO RELATED APPLICATIONS

None.

### FEDERALLY SPONSORED RESEARCH OR DEVELOPMENT

None.

### TECHNICAL FIELD

The invention relates to pharmacy labels, and more specifically, to pre-cut adhesive multi-dose pharmacy labels suitable for point-of-sale printing of information thereon.

### BACKGROUND OF THE INVENTION

Pharmacy labels for labeling drugs obtained from a pharmacist by prescription are well-known. Historically, most or all of the information on a pharmacy label was written by hand by the pharmacist or a pharmacy employee. Computer technology has greatly advanced the actions of collecting and keeping track of information related to a patient and prescription, and has allowed information to be printed on pharmacy labels at the point of sale, rather than handwritten. However, prior pharmacy labels and methods of creating the same have certain drawbacks and disadvantages.

The present invention is provided to solve the problems discussed above and other problems, and to provide advantages and aspects not provided by prior pharmacy labels of this type. A full discussion of the features and advantages of the present invention is deferred to the following detailed description, which proceeds with reference to the accompanying drawings.

### SUMMARY OF THE INVENTION

The present invention provides a pharmacy label including a patient section, a first drug section, and a second drug section. The patient section has patient-specific information printed thereon, the first drug section has first drug-specific information printed thereon, and the second drug section has second drug-specific information printed thereon. The patient-specific information is selected from the group consisting of: patient information, prescription information, warning information, barcode information, and vendor information. The first and second drug-specific information are selected from the group consisting of: drug information, instruction information, prescription information, physician information, warning information, and manufacturer information. The patient section further contains a prescription number printed thereon. The prescription number is correlated to the patient-specific information, the first drug-specific information, and the second drug-specific information

According to one aspect of the invention, the pharmacy label further includes divider lines printed on the label, visually dividing the patient section, the first drug section, and the second drug section.

According to another aspect of the invention, the pharmacy label further includes a third drug section having third drug-specific information specific to a third drug printed thereon. The third drug-specific information is selected from the group consisting of: drug information, instruction information, prescription information, physician information, warning information, and manufacturer information. The prescription number is further correlated to the third drug-specific information.

According to another aspect of the invention, the pharmacy label further includes a fourth drug section having fourth drug-specific information specific to a fourth drug printed thereon. The fourth drug-specific information selected from the group consisting of: drug information, instruction information, prescription information, physician information, warning information, and manufacturer information. The prescription number is further correlated to the fourth drug-specific information.

According to another aspect of the invention, the patient section contains preprinted information thereon, the preprinted information including vendor information.

According to another aspect of the invention, highlighting is preprinted on the label in the same location as selected information from the patient-specific information, the first drug-specific information, and the second drug-specific information.

According to another aspect of the invention, the patient-specific information includes patient information, prescription information, warning information, barcode information, and vendor information.

According to another aspect of the invention, the first drug-specific information includes drug information, instruction information, prescription information, physician information, warning information, and manufacturer information, and the second drug-specific information includes drug information, instruction information, prescription information, physician information, warning information, and manufacturer information.

The present invention also provides a pharmacy label assembly having a label portion releasably attached to a backing portion. The label portion includes a first label and a second label. The first label and the second label each include a patient section having patient-specific information printed thereon and a plurality of drug sections. Each drug section has drug-specific information printed thereon. The drug-specific information of each drug section is specific to a different drug. The patient-specific information of the first label and the second label are selected from the group consisting of: patient information, prescription information, warning information, barcode information, and vendor information.

According to one aspect of the invention, the patient-specific information of the first label and the patient-specific information of the second label are specific to the same patient.

According to another aspect of the invention, the drug-specific information of each drug section of the first label and the second label are selected from the group consisting of: drug information, instruction information, prescription information, physician information, warning information, and manufacturer information.

According to another aspect of the invention, the label portion further includes a third label including a patient section having patient-specific information printed thereon and a plurality of drug sections. Each drug section has drug-specific information printed thereon. The drug-specific information of each drug section is specific to a different drug.

According to another aspect of the invention, the first label and the second label are positioned vertically on the label assembly and the third label is positioned horizontally on the label assembly.

According to another aspect of the invention, the patient section of the first label further has a universal prescription number printed thereon. The universal prescription number is correlated to the patient-specific information of the first label and the drug-specific information of each drug section of the first label.

According to another aspect of the invention, the patient-specific information of the first label and the patient-specific information of the second label are specific to the same patient, and the patient section of the second label further has a universal prescription number printed thereon. The universal prescription number is correlated to the patient-specific information of the first label and the second label and the drug-specific information of each drug section of the first label and the second label.

The present invention further provides a pharmaceutical packaging assembly including a container, a plurality of different drugs, a plurality of single-use packets contained inside the container, and a label affixed to the container. Each packet contains at least one of the plurality of drugs to be taken together at a prescribed time. The label has a patient section containing patient-specific information printed thereon and a plurality of drug sections. Each of the drug sections contains drug-specific information printed thereon, specific to one of the plurality of drugs. The patient-specific information is selected from the group consisting of: patient information, prescription information, warning information, barcode information, and vendor information. The drug-specific information is selected from the group consisting of: drug information, instruction information, prescription information, physician information, warning information, and manufacturer information.

According to one aspect of the invention, the plurality of drugs includes four different drugs, and the label has four drug sections. Each of the four drug sections contains drug-specific information printed thereon, specific to one of the four drugs.

According to another aspect of the invention, the plurality of drugs is greater in number than the plurality of drug sections, and the pharmaceutical packaging assembly further includes a second label affixed to the container. The second label has a plurality of drug sections, and each of the drug sections contains drug-specific information printed thereon, specific to one of the plurality of drugs.

According to another aspect of the invention, the second label further has a patient section containing patient-specific information printed thereon, and the patient-specific information of the label and the patient-specific information of the second label are specific to the same patient.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a plan view of one embodiment of a pharmacy label of the present invention;

FIG. 2 is a perspective view of one embodiment of a pharmacy label of the present invention;

FIG. 3 is a plan view of a blank used for creating the pharmacy label of FIG. 1; and

FIG. 4 is a schematic view of a pharmaceutical packaging assembly using a pharmacy label of the present invention.

### DETAILED DESCRIPTION

While this invention is susceptible of embodiments in many different forms, there are shown in the drawings and will herein be described in detail preferred embodiments of the invention with the understanding that the present disclosure is to be considered as an exemplification of the principles of the invention and is not intended to limit the broad aspect of the invention to the embodiments illustrated.

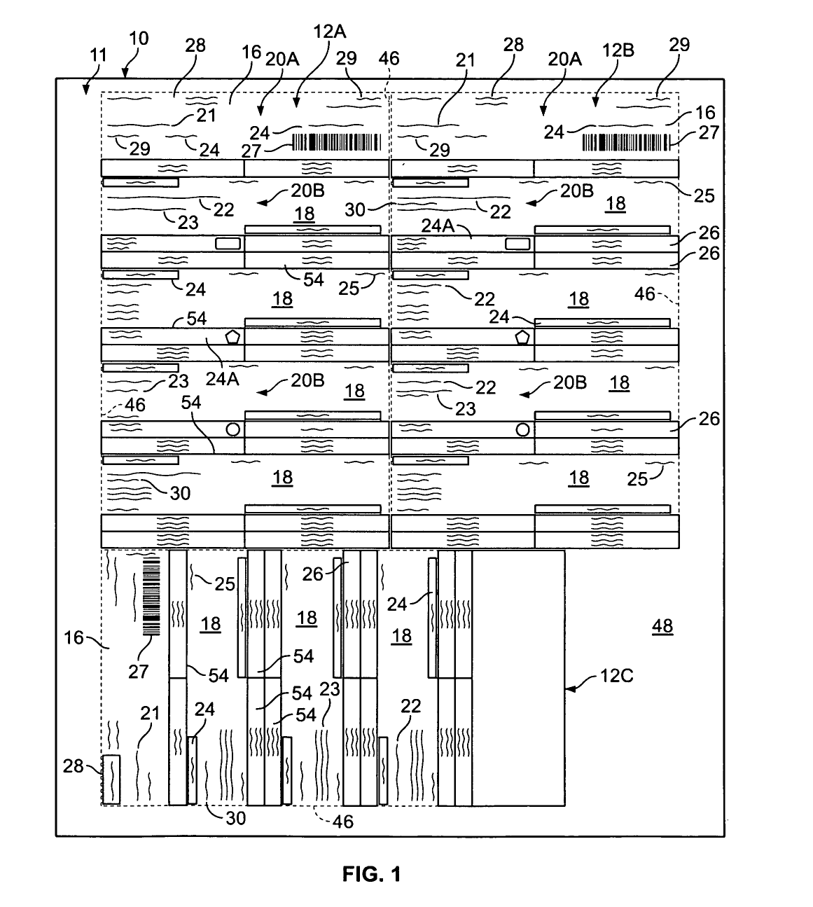

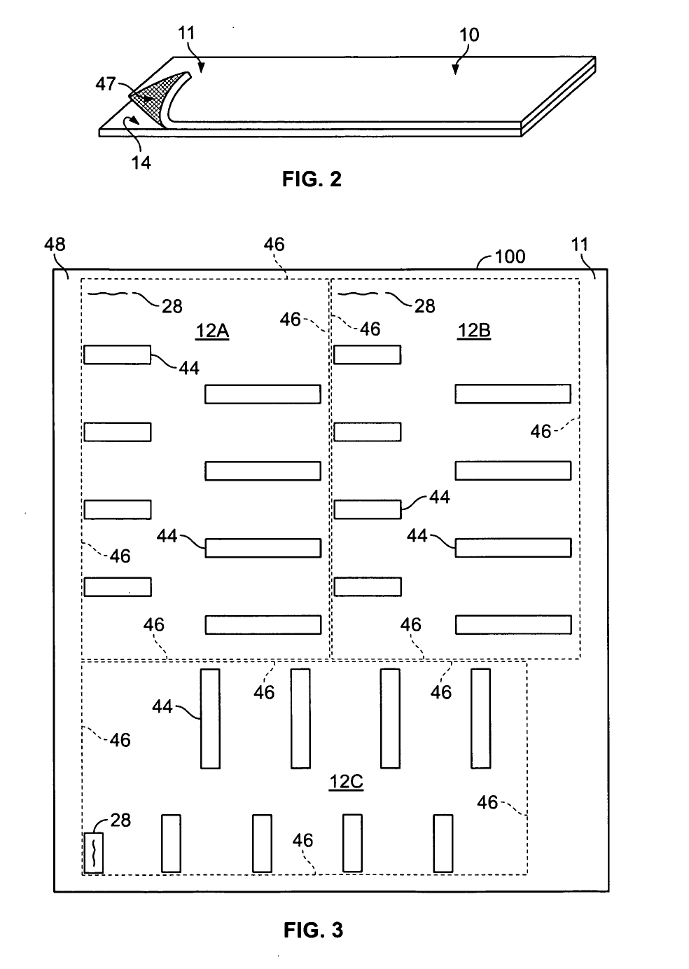

Referring to the FIGS., and initially to FIGS. 1 and 2, there is shown a pharmacy label assembly 10 having several types of information 20 printed thereon. The label assembly 10 preferably includes an label portion 11 and a removable backing portion 14 which is removably attached to the label portion 11. The label portion 11 preferably has at least one label 12 defined thereon, and may also have a border or skeleton 48 surrounding the label(s) 12 that remains after the label(s) 12 have been removed. Each label 12 is divided into several subsections, including a patient section 16, and a plurality of drug sections 18. The patient section 16 includes patient-specific information 20A printed thereon, which corresponds to a certain patient. Each of the plurality of drug sections 18 includes drug-specific information 20B printed thereon that is specific to a different drug being prescribed to the patient. In the embodiment shown, the label portion 11 includes three labels 12A,12B,12C, each divided into five subsections, including a patient section 16 and four drug sections 18. The labels 12 are preferably pre-cut, and are thus separable from each other.

Each label 12 includes one or more types of information 20 printed thereon. Such types of information preferably include patient information 21, drug information 22, instruction information 23, prescription information 24, physician information 25, warning information 26, barcode information 27, vendor information 28, sale information 29, and manufacturer information 30. The information 20 may also include one or more other types of useful information, including, without limitation, patient-specific, drug-specific, prescription-specific, physician-specific, and/or vendor-specific information. Preferably, each patient section 16 contains information 20A specific to a certain patient (patient-specific information 20A), and each drug section 18 contains information 20B specific to a certain drug (drug-specific information 20B). Additionally, all of the information 20 on each label is preferably specific to the same patient. Further, in some cases, the information 20 on each label may be specific to the same prescription and/or physician as well. It is understood that a label assembly 10 may be printed without printing on a specific label 12 or on one or more subsections 16,18 of each label 12.

Patient information 21, as shown in FIG. 1, contains information about the patient to whom the drug has been prescribed. The patient information 21 preferably includes the patient's name and address, and may also include other information, such as age, date of birth, phone number, email address, and identification information, for example a Social Security number or any other unique identification number. In different embodiments, the patient information 21 may contain any or all of the above information, and may contain additional information. Patient information 21 is preferably printed on the patient section 16, but may additionally or alternately be printed on one or more of the drug sections 18.

Drug information 22, as shown in FIG. 1, contains information about the drug which has been prescribed by the physician. The drug information 22 preferably includes the commercial name of the drug, the size/weight of the pills (or volume if the drug is liquid), the form of the drug (tablets, capsules, etc), and the chemical and/or generic name of the drug. In different embodiments, the drug information 22 may contain any or all of the above information, and may contain additional information. Drug information 22 is preferably printed on each drug section 18, but may additionally be printed on the patient section 16. In a preferred embodiment, each drug section 18 of a label 12 is dedicated to a different prescription drug for a single patient, who is identified by the patient information 21 on the patient section 16. Thus, each drug section 18 contains drug information 22 specific to the respective prescription drug to which the drug section 18 is dedicated.

Instruction information 23, as shown in FIG. 1, contains information regarding the proper method for administering the drug. The instruction information 23 preferably includes the proper dosage, the frequency of administering the drug, the means for administering the drug (mouth, injection, etc.), and the purpose for which the drug is used. In different embodiments, the instruction information 23 may contain any or all of the above information, and may contain additional information. Instruction information 23 is preferably printed on each drug section 18, but may additionally be printed on the patient section 16. Because each drug section 18 is dedicated to a different prescription drug, each drug section 18 contains instruction information 23 specific to the respective drug to which the drug section 18 is dedicated.

Prescription information 24, as shown in FIG. 1, contains information regarding the prescription rendered by the physician. The prescription information 24 preferably includes the prescription number, quantity of the drug, number of refills, expiration date of the prescription, identification information for the drug, and other information. Additionally, the prescription information 24 preferably contains pill information 24A, which describes the physical appearance of the prescribed drug for identification purposes. The pill information 24A contains a description of the color and shape of the pill, optionally including a depiction of the pill, as well as identification numerals found on one or both sides of the pill. While the label assembly 10 is typically used in connection with drugs in pill form, it is understood that prescribed medication may be delivered in a form other than a pill, such as liquid, an injectable syringe, an inhaler device, a mixable powder, etc. The pill information 24A, if present, may be modified for such drug forms. In different embodiments, the prescription information 24 may contain any or all of the above information, and may contain additional information. The prescription information 24, including the pill information 24A, is preferably printed on each drug section 18, and some prescription information 24 is preferably also printed on the patient section 16. Because each drug section 18 is dedicated to a different prescription drug, each drug section 18 contains prescription information 24 specific to the respective drug to which the drug section 18 is dedicated. In one embodiment, each drug section 18 contains a prescription number to identify the individual drug to which the drug section 18 is dedicated, and the patient section 16 contains a universal prescription number that covers all of the drugs in the particular assembly.

Physician information 25, as shown in FIG. 1, contains information regarding the physician who rendered the prescription. The physician information 25 preferably includes the physician's name, and may also include other information, such as the address of the physician's practice and the physician's phone number. In different embodiments, the physician information 25 may contain any or all of the above information, and may contain additional information. Physician information 25 is preferably printed on each drug section 18, but may additionally or alternately be printed on the patient section 16. Since it is possible that different drugs may be prescribed by different physicians, each drug section 18 contains physician information 25 specific to the respective drug to which the drug section 28 is dedicated.

Warning information 26, as shown in FIG. 1, contains information informing the patient of potential dangers or negative side effects involved with use of the drug and certain precautions to take in order to avoid or minimize potential dangers and negative side effects. The warning information 26 may include any applicable information for the drug, including warnings for patients in a certain physical condition (pregnancy, heart problems, etc.) not to use the drug, drug interaction information, warnings against certain activity while using the drug, and instructions on how and when to administer the drug to maximize its effectiveness and/or minimize potential negative side effects. Any other similar applicable information may be included within the warning information 26 as well. In different embodiments, the warning information 26 may contain any or all of the above information, and may contain additional information. Warning information 26 is preferably printed on each drug section 18. Because each drug section 18 is dedicated to a different prescription drug, each drug section 18 contains warning information 26 specific to the respective drug to which the drug section 18 is dedicated. Additionally, some general (non-drug-specific) warning information 26 is preferably printed on the patient section 16.

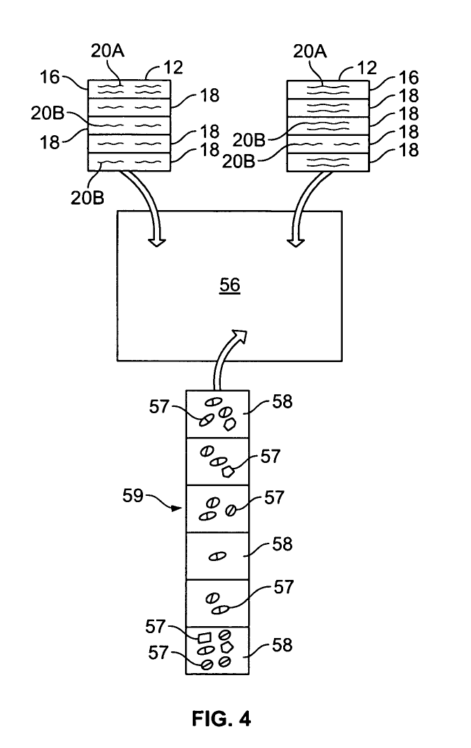

Barcode information 27, as shown in FIG. 1, comprises a machine-readable barcode, which can be used to quickly and easily correlate the label assembly 10 with a wide variety of information. For example, as shown in FIG. 4, scanning the barcode information 27 with a scanner 32 connected to a computer 34 on a network 36 would allow the computer 34 to retrieve the prescription information 24, patient information 21, and physician information 25 from the computer 34 itself or from another computer in the network 36. Moreover, the barcode information 27 can include a link to secure information such as a patient's social security number, health insurance plan information, medical diagnoses, and even medical and prescription history. In this way, the barcode information 27 can be correlated with any or all of the information 20 identified herein and/or other types of information. Because the barcode 27 is correlated with other information, actions such as refilling prescriptions can be performed more quickly and easily by using the barcode 27. Barcode information 27 is preferably printed on the patient section 16, but may additionally or alternately be printed on one or more of the drug sections 18. The barcode information 27 on the label 12 is preferably correlated with all of the other information 20 on the label.

Vendor information 28, as shown in FIG. 1, contains information regarding the vendor selling the drug to the patient. Most often, the vendor will be a pharmacy or a large store that has a pharmacy therein. The vendor information 28 preferably includes the vendor's name and/or logo, address (business and/or corporate), phone number, and website URL. In different embodiments, the vendor information 28 may contain any or all of the above information, and may contain additional information. Vendor information 28 is preferably printed on the patient section 16, but may additionally or alternately be printed on one or more of the drug sections 18.

Sale information 29, as shown in FIG. 1, contains information regarding the sale of the drug by the vendor. The sale information 29 preferably includes the date of sale, but may also include the price and any applicable discounts or rebates. The sale information 29 may also include information indicating whether the container 56 contains the patient's entire order, or whether additional packages are included (e.g., “Box 1 of 2”). In different embodiments, the sale information 29 may contain any or all of the above information, and may contain additional information. Sale information 29 is preferably printed on the patient section 16, but may additionally or alternately be printed on one or more of the drug sections 18.

Manufacturer information 30, as shown in FIG. 1, contains information regarding the manufacturer who produced the drug. The manufacturer information 30 preferably includes the name of the manufacturer, but may additionally or alternately contain other information. Manufacturer information 30 is preferably printed on each drug section 18, but may additionally be printed on the patient section 16. Because each drug section 18 is dedicated to a different prescription drug, each drug section 18 contains manufacturer information 30 specific to the respective drug to which the drug section 18 is dedicated.

The information 20 is preferably printed on the label assembly 10. “Printed,” as used herein, means automatic printing by an automatic printing device, such as a dot-matrix, inkjet, thermoprinting, or laser jet printer or other similar device. Printing is distinguished from manual methods such as handwriting or typing with a manual typewriter. In addition to the information 20, each of the label subsections 16,18 may have additional printing thereon. For example, in the label assembly 10 shown in FIG. 1, each subsection 16,18 has divider lines 54 printed thereon to visually separate the various subsections 16,18, as well as separating different types of information on each subsection, for organizational purposes.

Prior to use, the label assembly 10 is preferably a single piece that includes the backing 14 and the label portion 11, as illustrated in FIGS. 1 and 2. The labels 12 are preferably pre-cut out of the label portion 11 with several die cut lines 46 defining and dividing the labels 12. In an alternate embodiment, the die cut lines 46 may also divide apart the subsections 16,18 of each label 12. Each label 12 preferably has a rectangular die cut line 46 defining the edge thereof and separating the label 12 from other parts of the label portion 11. Normally, the die cut lines 46 will leave the border portion 48 of excess material from the label portion 11 surrounding the labels 12. In other embodiments, the label assembly 10, the labels 12, and/or the subsections 16,18 may be differently sized and shaped, each label assembly 10 may contain a greater or smaller number of labels 12, and each label 12 may contain a greater or smaller number of subsections 16,18. The label assembly 10 should have a sufficient number of die cut lines 46 to define and separate any and all desired parts of the label portion 11. The die cut lines 46 are preferably die-cut prior to printing and may be solid cuts or perforated cuts which can be easily ripped apart.

The label portion 11 is removably attached to the backing 14, preferably by an adhesive 47, as illustrated in FIG. 2. Thus, the labels 12 remain attached to the backing 14 unless removed. The backing 14 is preferably a sheet of paper having a waxed surface or other low-stick surface, so the adhesive 47 can adhere to the backing 14, but releases without tearing any portion of the backing 14. Due to the die cut lines 46, the labels 12 are completely separable from each other. That is, each label 12 may be removed from the backing 14 independently of another label 12. Thus, when the label assembly 10 is desired to be used, each label 12 is peeled from the backing 14 and affixed to a container 56 or other desired article, as shown in FIG. 3. Because each label 12 may contain all the necessary information 20 for all of the prescription drugs contained in the container 56 (e.g., patient information 21, drug information 22, instruction information 23, prescription information 24, physician information 25, warning information 26, barcode information 27, vendor information 28, sale information 29 and/or manufacturer information 30), there is a significant time savings and a reduced chance that multiple labels for different prescriptions could get mixed up.

In a preferred embodiment, the label portion 11 is comprised of a facestock that is a smooth bright white paper with a medium sensitivity direct thermal coating, which makes it especially well suited for thermoprinting. Even more preferably, the facestock includes a topcoat to provide maximum protection from contaminants and added resistance to water and oils to prevent alteration of the above-identified types of information 20 to be printed on the label portion 11. The adhesive 47 should be well suited for adhesion to paper, corrugated paper stock and plastics. And the backing 14 should have a high internal strength and tear resistance and be well adapted to be used in roll-to-roll label applications. Label material especially well suited for use in the present invention has a face sheet of 6.7 mil white laser paper, a liner of #44 layflat liner, and a permanent acrylic adhesive having a service range of −4° F. to 248° F. This material can be stored for one year at 72° F. and 50% relative humidity.

The present invention also provides a method of creating the label assembly 10. A preferred embodiment of the method is illustrated in FIG. 4, and includes several steps. It is understood that the method may not incorporate all the steps set forth below, and may contain additional steps not identified. Further, it is understood that the steps may be performed in a different order than set forth below, if feasible.

First, a blank label assembly 100 is provided, including a backing sheet 14 and a label portion 11 removably attached to the backing sheet, and is illustrated in FIG. 3. The label portion 11 is then pre-cut to separate the labels 12 from each other, leaving a skeleton 48 of unused label portion 11. The label assembly 10 shown in FIG. 1 contains three labels 12—two labels 12A,12B positioned vertically next to each other, and the third label 12C positioned horizontally below the first two labels 12A,12B. As described above, the pre-cutting is preferably done by a die cutter, creating die-cut lines 46. Due to the die-cutting, the labels 12 may be independently and individually removed from the backing sheet 14. Information 20 or other indicia may also be pre-printed onto the label assembly 10. For example, in one embodiment, some vendor information 28 (such as a logo) and several highlighted portions 44 are pre-printed onto each label 12 in the label assembly 10. The highlighted portions 44 are positioned so that important information 20 will eventually printed over them, causing the information 20 to be highlighted. After this step, the label assembly 10 is ready for printing. Often, the previous steps will be performed at a remote location, such as a manufacturing facility, and the printable label assemblies 10 are then transported to the point of sale, which is typically a vendor such as a distribution center or a pharmacy, for printing and use. The label assemblies 10 may be separate, or a plurality of label assemblies 10 may be printed on a large roll of blank 100 to be later separated at the pharmacy.

When the label assembly 10 is needed for a prescription at the point of sale, the vendor can use a printer or other device to print the label assembly 10. Information 20 is printed on the label 12, preferably including patient information 21, drug information 22, instruction information 23, prescription information 24, physician information 25, warning information 26, barcode information 27, vendor information 28, sale information 29, and manufacturer information 30. As stated above, each drug section 18 preferably contains drug information 22, instruction information 23, prescription information 24, physician information 25, warning information 26, and manufacturer information 30, and at least some of the information 20 on the drug section 18 is drug-specific information 20B. The patient section 16 includes patient information 21, prescription information 24, warning information 26, barcode information 27, and vendor information 28, and at least some of the information 20 on the patient section 16 is patient-specific information 20A. Preferably, most or all of the information 20 on the drug sections 18 is drug-specific information 20B, and most or all of the information 20 on the patient section 26 is patient-specific information 20A. Certain types of information, such as vendor information 28, may not be patient-specific or drug-specific. As stated above, printing on all of the labels 12 or on all of the drug sections 18 within a particular label 12 may not always be necessary or desirable. The pharmacy can decide which information is necessary to be printed on the label assembly 10, and may print different types of information on different label assemblies 10 based on different considerations, including patient-specific, prescription-specific, or drug-specific considerations. This decision can be made by pharmacy employees or automatically by a pharmacy computer. Additionally, each label assembly 10 is preferably used for a single patient, and superfluous labels 12 not required for the patient's prescription are discarded. However, in another embodiment, labels 12 for different patients may be printed on the same label assembly 10. Finally, the labels 12 may be removed from the backing 14 and applied to a suitable article or articles.

In one preferred embodiment, the label assembly 10 is used in connection with a multi-drug, multi-dose pharmaceutical packaging assembly, in which a plurality of drugs are packaged together in a single container 56, as shown in FIG. 4. In such an arrangement, each label 12 can be affixed to a single container, with the drug sections 18 providing information about all of the individual drugs contained in the container 56. In the event that the container 56 contains fewer drugs than the number of drug sections 18 on the label 12, one or more of the drug sections 18 can be left blank, as appropriate. In the event that the prescription calls for a greater number of drugs than the number of drug sections 18 on the label, the drugs may be packaged in separate containers 56, each having a separate label 12, or more than one label 12 may be affixed to a single container 56. As described above, a single prescription number can be correlated with a particular multi-drug assembly, and this prescription number is preferably printed on the patient section 16 of each label.

Such multi-drug, multi-dose containers 56 often contain a series of single-use packets 58, with each packet 58 containing a single dose of several drugs intended to be taken together, based on the prescription. The single-use packets 58 are then packaged together in a single container 56 for shipping or otherwise transmitting to the customer. Accordingly, the present invention also provides a packaging assembly for packaging a plurality of drugs 57, including a container 56 containing a plurality of single-use packets 58, each packet 58 containing at least one of the number of drugs 57 to be taken at a prescribed time, and a label 12 as described above attached to the container 56. Automated multi-drug, multi-dose filling machines can use prescription data, such as dose size and scheduling, to automatically fill the series of single-use packets 58. Such automated filling machines typically create a chain 59 of single-use packets 58 from a large polymer bag or tube by heat sealing individual compartments in the bag or tube to form the individual packets 58. One manufacturer of such automated filling machines is Automed Technologies, Inc.

The label assembly 10 provides many benefits. Because all of the relevant and necessary information 20 can be printed on the labels 12, handwriting such information 20 is not necessary. Thus, filling prescriptions is made quicker, easier, and more convenient. Additionally, because the label assembly 10 contains barcode information 27 correlated via computer 34 to other relevant information, such information can be retrieved simply by scanning the barcode 27. Thus, refilling prescriptions and filling other prescriptions for the same patient is made quicker, easier, and more convenient. Further, the labels 12 each contain space for a plurality of drug sections 18, so each label 12 can contain a great deal of information 20 that may not have fit onto prior labels. This is particularly useful when packaging a number of different prescription medications together, such as when filling prescriptions by shipping the medications, rather than by in-person transmittal.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the spirit or central characteristics thereof. The present examples and embodiments, therefore, are to be considered in all respects as illustrative and not restrictive, and the invention is not to be limited to the details given herein. The terms “first,” “second,” “horizontal,” “vertical,” etc., as used herein, are intended for illustrative purposes only and do not limit the embodiments in any way. Additionally, the terms “plurality,” as used herein, indicates any number greater than one, either disjunctively or conjunctively, as necessary, up to an infinite number. Accordingly, while the specific embodiments have been illustrated and described, numerous modifications come to mind without significantly departing from the spirit of the invention and the scope of protection is only limited by the scope of the accompanying claims.

What is claimed is:

1. A pharmacy label comprising:
a patient section having patient-specific information printed thereon, the patient-specific information selected from the group consisting of: patient information, prescription information, warning information, and barcode information;
a first drug section having first drug-specific information specific to a first drug printed thereon, the first drug-specific information selected from the group consisting of: drug information, instruction information, prescription information, physician information, warning information, and manufacturer information; and
a second drug section having second drug-specific information specific to a second drug printed thereon, the second drug-specific information selected from the group consisting of: drug information, instruction information, prescription information, physician information, warning information, and manufacturer information,
wherein the patient section further contains a prescription number printed thereon, the prescription number correlated to the patient-specific information, the first drug-specific information, and the second drug-specific information.

2. The pharmacy label of claim 1, further comprising divider lines printed on the label, visually dividing the patient section, the first drug section, and the second drug section.

3. The pharmacy label of claim 1, further comprising a third drug section having third drug-specific information specific to a third drug printed thereon, the third drug-specific information selected from the group consisting of: drug information, instruction information, prescription information, physician information, warning information, and manufacturer information, wherein the prescription number is further correlated to the third drug-specific information.

4. The pharmacy label of claim 3, further comprising a fourth drug section having fourth drug-specific information specific to a fourth drug printed thereon, the fourth drug-specific information selected from the group consisting of: drug information, instruction information, prescription information, physician information, warning information, and manufacturer information, wherein the prescription number is further correlated to the fourth drug-specific information.

5. The pharmacy label of claim 1, wherein the patient section contains preprinted information thereon, the preprinted information including vendor information.

6. The pharmacy label of claim 1, wherein highlighting is preprinted on the label in the same location as selected information from the patient-specific information, the first drug-specific information, and the second drug-specific information.

7. The pharmacy label of claim 1, wherein the patient-specific information includes patient information, prescription information, warning information, and barcode information, and the patient section further has vendor information printed thereon.

8. The pharmacy label of claim 1, wherein the first drug-specific information includes drug information, instruction information, prescription information, physician information, warning information, and manufacturer information, and the second drug-specific information includes drug information, instruction information, prescription information, physician information, warning information, and manufacturer information.

9. A pharmacy label assembly having a label portion releasably attached to a backing portion, the label portion comprising:
a first label comprising a patient section having patient-specific information printed thereon and a plurality of drug sections, each drug section having drug-specific information printed thereon, wherein the drug-specific information of each drug section is specific to a different drug; and
a second label comprising a patient section having patient-specific information printed thereon and a plurality of drug sections, each drug section having information printed thereon, wherein the drug-specific information of each drug section is specific to a different drug.

10. The pharmacy label assembly of claim 9, wherein the patient-specific information of the first label is selected from the group consisting of: patient information, prescription information, warning information, barcode information, and vendor information, and the patient-specific information of the second label is selected from the group consisting of: patient information, prescription information, warning information, barcode information, and vendor information.

11. The pharmacy label assembly of claim 9, wherein the patient-specific information of the first label and the patient-specific information of the second label are specific to the same patient.

12. The pharmacy label assembly of claim 9, wherein the drug-specific information of each drug section of the first label is selected from the group consisting of: drug information, instruction information, prescription information, physician information, warning information, and manufacturer information, and the drug-specific information of each drug section of the second label is selected from the group consisting of: drug information, instruction information, prescription information, physician information, warning information, and manufacturer information.

13. The pharmacy label assembly of claim 9, wherein the label portion further comprises a third label comprising a patient section having patient-specific information printed thereon and a plurality of drug sections, each drug section having drug-specific information printed thereon, wherein the drug-specific information of each drug section is specific to a different drug.

14. The pharmacy label assembly of claim 13, wherein the first label and the second label are positioned vertically on the label assembly and the third label is positioned horizontally on the label assembly.

15. The pharmacy label assembly of claim 9, wherein the patient section of the first label further has a universal prescription number printed thereon, the universal prescription number correlated to the patient-specific information of the first label and the drug-specific information of each drug section of the first label.

16. The pharmacy label assembly of claim 15, wherein the patient-specific information of the first label and the patient-specific information of the second label are specific to the same patient, and wherein the patient section of the second label further has a universal prescription number printed thereon, the universal prescription number correlated to the patient-specific information of the first label and the second label and the drug-specific information of each drug section of the first label and the second label.

17. A pharmaceutical packaging assembly comprising:
a container;
a plurality of different drugs;
a plurality of single-use packets contained inside the container, each packet containing at least one of the plurality of drugs to be taken at a prescribed time; and
a label affixed to the container, the label having a patient section containing patient-specific information printed thereon and a plurality of drug sections, each of the drug sections containing drug-specific information printed thereon, specific to one of the plurality of drugs,
wherein the patient-specific information is selected from the group consisting of: patient information, prescription information, warning information, barcode information, and vendor information, and the drug-specific information is selected from the group consisting of: drug information, instruction information, prescription information, physician information, warning information, and manufacturer information.

18. The pharmaceutical packaging assembly of claim 17, wherein the plurality of drugs comprises four different drugs, and the label has four drug sections, each of the four drug sections containing drug-specific information printed thereon, specific to one of the four drugs.

19. The pharmaceutical packaging assembly of claim 17, wherein the plurality of drugs is greater in number than the plurality of drug sections, and the pharmaceutical packaging assembly further comprises a second label affixed to the container, the second label having a plurality of drug sections, each of the drug sections containing drug-specific information printed thereon, specific to one of the plurality of drugs.

20. The pharmaceutical packaging assembly of claim 19, wherein the second label further has a patient section containing patient-specific information printed thereon, and wherein the patient-specific information of the label and the patient-specific information of the second label are specific to the same patient.
